(19) United States
(12) Patent Application Publication
(10) Pub. No.: US 2014/0282396 A1
(43) Pub. Date: Sep. 18, 2014

(54) COMPUTERIZED SYSTEM AND METHOD FOR EXTRACTING BUSINESS RULES FROM SOURCE CODE

(71) Applicant: Syntel, Inc., Troy, MI (US)

(72) Inventor: Chetan Manjarekar, Pune (IN)

(21) Appl. No.: 14/211,826

(22) Filed: Mar. 14, 2014

Related U.S. Application Data
(60) Provisional application No. 61/781,410, filed on Mar. 14, 2013.

(51) Int. Cl. G06F 9/44

(52) U.S. Cl. CPC G06F 8/70
USPC 717/120

(57) ABSTRACT

Systems, methods, and computer program products for extracting business rules from source code are disclosed. The system includes a receiver module on a computer, an analysis module on a computer, and an extraction module on a computer. The receiver module may receive source code and a copybook associated with the source code. The analysis module may analyze the source code to identify a dependency on a portion of the copybook, append the identified portion of the copybook to the identified dependency in the source code to create a consolidated source code file and identify one or more business rules from the consolidated source code file. The extraction module may extract the one or more business rules from the consolidated source code file.

### CROSS-REFERENCE TO RELATED APPLICATIONS

This application claims priority to, and the benefit of, U.S. Provisional Application Ser. No. 61/781,410, filed Mar. 14, 2013 and entitled “Computerized System and Method for Extracting Business Rules from Source Code,” the disclosure of which is incorporated herein by reference in its entirety.

### TECHNICAL FIELD

This disclosure relates generally to computerized systems; in particular, this disclosure relates to computer systems programmed to analyze source code to extract business rules embedded in the source code.

### BACKGROUND

Source code is a set of computer instructions written in a human-readable format. The instructions are written in a computer programming language that can be executed by a processor after being compiled or interpreted into machine-readable instructions. There are circumstances in which analysis of source code to determine program flow and/or business rules can be useful.

However, for large applications, e.g., with thousands or millions of lines of source code, manual analysis of the source code may be prohibitively time consuming and fraught with human error. For example, manual detection of associated dependencies within a program, such as identifying embedded copybooks (dependencies) can be very time consuming and highly susceptible to human error. Moreover, manual tracing of application flow and variable flow can be quite complex and highly dependent on human knowledge.

Further still, manually translating identified rules within the application logic into a format that can be easily understood by both technical and business teams typically requires additional human resources. And once such rules are extracted and documented in an appropriate format, an equally complex and time consuming task of creating artifacts which are understood by business-rule, management system (“BRMS”) products follows. Moreover, the amount of time and resources required of business users to explain the same rules to a technical team to ensure that the logic is clearly understood and built into the BRMS product, carries its own associated risks and significant time to resolve any queries. The entire process of creating relevant documents catering to both technical and business teams can therefore be quite challenging and involve a considerable amount of repetition.

### SUMMARY

This disclosure relates to a software tool that can identify and extract business rules which are embedded within the source code of a software application. The tool aids modernization of legacy software applications by efficiently and effectively identifying the specific areas of source code of applications where probable business rules could exist. The tool focuses on extracting and separating out business and technical logic from legacy applications in an automated fashion thereby drastically reducing manual intervention. This tool uses pattern-based algorithm to automatcially identify those sections of codes which may contain business rules.

An organization leveraging the tool can minimize the manual process of identifying the embedded application logic, such as within COBOL programs The tool provides detailed and exhaustive documentation in the form of a spreadsheet, such as using Microsoft Excel, which helps eliminate manual creation of the rule specifications. Additionally, the tool provides the functionality of extracting the rules, enables users to categorize the business rules and finally import the same into a BRMS product. This approach saves substantial amounts of overall time in creating the artifacts into the BRMS product manually. Overall, this tool automates a complex, repetitive task which, if done manually, will incur huge human effort with a high risk of errors.

According to an aspect of the disclosure, a system for extracting business rules from source code may include one or more computers, a receiver module, an analysis module, and an extraction module each on at least one of the one or more computers. The receiver module may receive source code and a copybook associated with the source code. The analysis module may analyze the source code to identify a dependency on a portion of the copybook, append the identified portion of the copybook to the identified dependency in the source code to create a consolidated source code file and identify one or more business rules from the consolidated source code file. The extraction module may extract the one or more business rules from the consolidated source code file.

In some cases, the analysis module may analyze the source code to identify missing dependencies of one or more missing copybooks, wherein the one or more missing copybooks may comprise one or more copybooks yet to be received by the system. Alternatively or additionally, the analysis module may further identify the one or more business rules based on a pattern driven search. Alternatively or additionally still, the analysis module may categorize the identified one or more business rules based on business terms and technical terms. The system may also comprise a conversion module to convert the extracted one or more business rules to a format suitable for importation into a business rule management system product. The system may also comprise a display module to graphically display information from at least one of the foregoing modules.

Additional features and advantages of the invention will become apparent to those skilled in the art upon consideration of the following detailed description of the illustrated embodiment exemplifying the best mode of carrying out the invention as presently perceived. It is intended that all such additional features and advantages be included within this description and be within the scope of the invention.

### BRIEF DESCRIPTION OF THE DRAWINGS

The present disclosure will be described hereafter with reference to the attached drawings which are given as non-limiting examples only, in which:

FIG. 1 is a simplified flow chart showing example steps that could be taken in analyzing the source code of a program;

FIGS. 2-13 are screenshots showing possible user interfaces and functions that could be provided in an embodiment of the tool; and

FIG. 14 is a simplified diagram of an embodiment of a system for extracting business rules from source code.

Corresponding reference characters indicate corresponding parts throughout the several views. The components in the figures are not necessarily to scale, emphasis instead being placed upon illustrating the principals of the invention. The exemplification set out herein illustrates embodiments of the invention, and such exemplification is not to be construed as limiting the scope of the invention in any manner.

### DETAILED DESCRIPTION OF THE DRAWINGS

While the concepts of the present disclosure are susceptible to various modifications and alternative forms, specific exemplary embodiments thereof have been shown by way of example in the drawings and will herein be described in detail. It should be understood, however, that there is no intent to limit the concepts of the present disclosure to the particular forms disclosed, but on the contrary, the intention is to cover all modifications, equivalents, and alternatives falling within the spirit and scope of the disclosure.

FIG. 1 is a flow chart showing example steps that could be taken in analyzing a COBOL program; however, this disclosure is not intended to be limited to a particular programming language and could be used with a variety of programming languages. In the example shown, the required COBOL files in the form of text files are provided as an input (such as via a receiver module). This could be specified by the user (block 100) or the user could select a file that has already been uploaded for processing (block 102). FIGS. 2 and 3 are screenshots showing an embodiment by which the user could specify the location of a COBOL file (such as using browse button 200 and then selecting the upload button 202) or by selecting a previous file (such as using the drop-down list 204 and then selecting the select file button 206). The tool (e.g., the analysis module) analyzes the dependency pertaining to associated copybooks and provides the user with the results (block 104). As described herein, a copybook may refer to a piece of code for insertion into other programs. The copybook may be used for various reasons including but not limited to copying file descriptions and record layouts into data divisions of programs that access the same common set of files.

The user is prompted to select a common location of the copybooks (block 106) which the tool reads and appends the relevant code, thereby creating a consolidated code to be extracted (block 108). FIG. 3 is a screenshot showing an embodiment by which a user could view the results of a dependency analysis. As shown in FIG. 3, dependencies may be identified by reference and type. For example, the dependency referenced as “DMSXXKC” is classified as a copybook type. Also from the example screenshot in FIG. 3, the user is able to add copybooks. For example, the user could select the “add copybook” button 300 and then identify the location of a copybook using the browse button 302, as shown in FIG. 4. FIG. 5 is a screenshot confirming that the selected copybooks (such as from the screenshot in FIG. 4) have been added. Also, FIG. 5 lists dependencies that are missing. As an example, these dependencies may refer to programs or copybooks that are referenced from within the selected COBOL file but not part of the currently within the system tool. They may have been identified using “CALL” and “COPY” statements which may not be mapped to available source files. The tool leverages a pattern-driven search and intelligently identifies the probable business rules from the application logic (block 110). The results are persisted in a database thereby giving users a flexibility to work on the extracted rules, as well as perform backend database queries for additional reporting. FIG. 6 is a screenshot showing an embodiment by which the user can do pattern-driven searching. As shown, the user may select from various pattern formats including but not limited to: “IF-END-IF”, “PERFORM”, “EVALUATE”, and “PARAGRAPH”. FIG. 7 is a screenshot identifying the extracted rules with relevant details to manage traceability (block 112). As shown, the tool lists a paragraph of the extracted rule, the name of the file from which it resides, the pattern format searched to identify the extracted rule, a rule ID, a rule condition, a rule action, the rule dependency, and a drop down menu for a user to select the rule type. As described herein, rule actions may define what is to be done when an “if” part of a rule is true or false. Rule actions may define actions in the “then” and “else parts of a rule. A rule action may consist of at least one action phrase that is executed when the “if” part of a rule is true, and additional optional action phrases that are executed when the “if” part of the rule is false. As used herein, a rule condition may determine circumstances under which a rule action in “then” and “else” parts of a rule are carried out. The rule condition may be defined in the “if” part of a rule, or elsewhere.

As shown in FIG. 7, a rule was identified in paragraph “P5XA4A-SORT-PBOTS-02”, which is a part of a file named “999 txt”. The rule was found via an “IF-END-IF” pattern search, and has a rule ID of “35”. The rule condition for this identifed rule is shown as “AND I PBGTS-SOI-ID (SUB1) NOT GREATER PBGTS-SOI-ID (SUB2)” and an associated rule action of “MOVE PBGTS-TABLE-ELEMENTS (SUB1) TO PWGA4-SAVE-SOI-GROUP-TABLE MOVE PBGTS-TABLE-ELEMENTS . . . ”FIG. 7 also illustrates capabilities of the tool including the generation of a rules report, updating an already generated report, and documenting rules. As shown, the tool can also provide a graphical representation of rules hierarchy in the form of tree like structure thereby enabling the users to better understand the execution flow at a program level (block 114). The tool facilitates output in the form of spreadsheets creating separate ones for different patterns present in the program with an export of basic rule hierarchy too.

In some embodiments, the tool enables business users to manage the rule specifications of currently extracted rules into a format which are easily understood by the business team (block 116). This is enabled in the form of building and managing a business rule glossary to manage the mapping between the extracted technical terms and the business terms (block 118). This process facilitates conversion of the extracted technical rules in a format easily recognizable and understood by the business team. FIG. 8 is a screenshot showing an example user interface for mapping the extracted rules. Also as described herein and shown in FIG. 8 at 806, the tool shows any imported rules to be analyzed and mapped similar to other rules operated on by the tool. For example, the user interface includes a rule by the technical term 800 and the ability to provide a corresponding business term 802, along with a term description 804. The term may be of many types including but not limited to: string, short, long, int, float, double, date, byte, and boolean. Business rules can be defined and managed in a decision table structure which is similar to the construct of a spreadsheet which enables efficient and effective representation of business rules. The contents, which are defined in the decision table construct, can be easily imported into BRMS products such as FICO's Blaze Advisor.

Other information can be displayed as well, such as a terms glossary (block 120) and/or imported rules (block 122). The user may enter other details about the imported rules for display (block 124), and export this information in a Microsoft Excel™ or Microsoft Word™ format (block 126). However, it is contemplated that other reporting formats may be available.

FIG. 9 is an example report, which may include a technical rules report 900 and a business rules report 902 based on the mapping step. For example, and as shown, the report may include such details associated with the rule such as paragraph origin 904, file name 906, pattern name 908, rule ID 910, rule condition 912, rule action 914, dependency type 916, rule type 918, line of business (“LOB”) 920, and or business rule interpretation 922. It should be noted that the report is not limited to these details. Other information related to extracted rules may be displayed as well.

Through use of the tool, the user may create a decision table template (block 128). The tool may then take that created template, and create a decision table (block 130). Alternatively, the user may manually create a decision table (block 132). The created decision table may then be exported (block 134).

FIG. 10 is an example screenshot showing use of the tool for creation of a decision table. The user may enter the name of a table in field 1002. The user may also enter the number of rule conditions at 1004 and corresponding rule actions at 1006. Adjacent to this screen is an example decision table 1008. This can be exported to a tool-readable format or imported into a rules engine repository. The user may also enter condition and action specifics at 1010, 1012, and 1014. There may be instances where the user wishes to modify row entries. Accordingly, the user may add a row entry by selecting box 1016 or delete a row entry by selecting box 1018.

FIG. 11 is a screenshot showing management of an example decision table. FIG. 11 also shows options for adding a new table at 1102, FIG. 12 is a screenshot showing an example manner by which rules maintenance could be performed. For example, the user may select an imported rule via radio button 1201. The selected rule(s) may be exported as shown in the example screenshot 1302 of FIG. 13. A report showing other information about the rule may also be displayed and exported, an example of which is shown in 1304. More specifically, this report may display details such as the rule release, rule name, version number, rule description, rule type id, start date, end date, execution schedule, rule composition, ruleset, rule flag status, execution details, comments, and creation particulars. It should be noted that other details may be shown as well. Screenshot 1306 is a snippet of this information display in a spreadsheet format.

In light of the disclosure herein, those of ordinary skill in the art would understand that the steps and processes discussed herein may be performed by various modules. For example, processes performed at blocks 100, 102, and 106 may be performed by a receiver module. Processes performed at blocks 104, 110, 116, and 118 may be performed by an analysis module. Other processes related to the extraction of business rules (such as at block 108) may be performed by an extraction module. And yet other processes related to conversion of extracted rules for export (such as at block 126) may be performed by a conversion module.

The term “module” includes an identifiable portion of computer code, computational or executable instructions, data, or computational object to achieve a particular function, operation, processing, or procedure. A module may be implemented in software, hardware/circuitry, or a combination of software and hardware. An identified module of executable code, for example, may comprise one or more physical or logical blocks of computer instructions that may, for instance, be organized as an object, procedure, or function. Nevertheless, the executables of an identified module need not be physically located together, but may comprise disparate instructions stored in different locations which, when joined logically together, comprise the module and achieve the stated purpose for the module. Indeed, a module of executable code could be a single instruction, or many instructions, and may even be distributed over several different code segments, among different programs, and across several memory devices. Similarly, modules representing data may be embodied in any suitable form and organized within any suitable type of data structure. The data may be collected as a single data set, or may be distributed over different locations including over different storage devices.

FIG. 14 is a simplified diagram of a system 10 for extracting business rules from source code. The system 10 may include any number, N, of computing devices 12₁-12_{N}, where N may be any positive integer. Each of the computing devices 12₁-12_{N} is communicatively coupled, or can be communicatively coupled, to one or more of the other computing devices 12₁-12_{N} via a conventional wired or wireless network 14.

Each computing device 12₁-12_{N} illustratively includes the features shown in the computing device 12₁, and it will be understood that each module described above may operate on one or several computing devices. The operation of extracting business rules from source code, as described hereinabove, may thus be carried out solely on a single computing device, e.g., 12₁, or in-part on two or more of the computing devices 12₁-12_{N}. Likewise, the operation of any one of the modules described above may be carried out solely on a single computing device, e.g., 12₁, or in-part on two or more of the computing devices 12₁-12_{N}.

Each computing device 12₁-12_{N}, illustratively includes a conventional processor 16 communicatively coupled to a conventional memory device 18 and to a conventional display monitor 20. The memory device 18 illustratively includes the modules described above, e.g., in the form of instructions which, when executed by the processor 16, cause the processor 16 to carry out the various operations of the modules. For example, the memory includes a receiver module 30 which receives the source code 32, e.g., the COBOL program in the example of FIG. 1, and a copybook 34 associated with the source code 32. The memory device 18 further includes an analysis module 40 which analyzes the source code 32 to identify a dependency on a portion of the copybook 34, appends the identified portion of the copybook to the identified dependency in the source code to create a consolidated source code file (CSCF) 42, and identifies one or more business rules from the consolidated source file 42. Illustratively, the analysis module 30 may further analyze the source code 32 to identify missing dependencies of one or more missing copybooks, i.e., one or more copybooks yet to be received. Alternatively or additionally, the analysis module 30 may categorize the identified one or more business rules based on business terms and on technical terms, and may further map the technical terms to the business terms.

The memory device 18 further includes an extraction module 50 which extracts the one or more business rules 52 from the consolidated source code file 42. Illustratively, the memory device 18 further includes a conversion module 60 which converts the extracted business rules 52 to a format 62 suitable for importation into a business rule management system (BRMS) product. The memory device 18 further includes a display module 70 which provides for the graphical display of information produced and/or operated upon by any one or more of the foregoing modules 30, 40, 50 and/or 60, and/or for the graphical display of any one or more of the reports described hereinabove.

Although the present disclosure has been described with reference to particular means, materials, and embodiments, from the foregoing description, one skilled in the art can easily ascertain the essential characteristics of the invention and various changes and modifications may be made to adapt the various uses and characteristics without departing from the spirit and scope of the invention.

What is claimed is:

1. A system for extracting business rules from source code, the computer system comprising:
one or more computers;
a receiver module on at least one of the one or more computers to receive the source code and to receive a copybook associated with the source code;
an analysis module on at least one of the one or more computers to analyze the source code to identify a dependency on a portion of the copybook, to append the identified portion of the copybook to the identified dependency in the source code to create a consolidated source code file and to identify one or more business rules from the consolidated source code file; and
an extraction module on at least one of the one or more computers to extract the one or more business rules from the consolidated source code file.

2. The system of claim 1, wherein the analysis module to analyze the source code to identify missing dependencies of one or more missing copybooks, the one or more missing copybooks comprising one or more copybooks yet to be received by the system.

3. The system of claim 1, wherein the analysis module to identify the one or more business rules based on a pattern driven search.

4. The system of claim 1, wherein the analysis module to categorize the identified one or more business rules based on business terms and on technical terms.

5. The system of claim 4, wherein the analysis module to map the technical terms to the business terms.

6. The system of claim 1, further comprising a conversion module to convert the extracted one or more business rules to a format suitable for importation into a business rule management system product.

7. The system of claim 1, further comprising a display module to graphically display information from at least one of the modules.

8. The system of claim 7, wherein the display module to graphically display at least some of the information according to a hierarchical tree structure.

9. A computerized system for extracting business rules from source code, the system comprising:
a processor, and
a memory having instructions stored therein which, when executed by the processor, cause the processor to
receive the source code and receive a copybook associated with the source code;
analyze the source code to identify a dependency on a portion of the copybook;
append the identified portion of the copybook to the identified dependency in the source code to create a consolidated source code file;
identify one or more business rules from the consolidated source code file; and
extract the one or more business rules from the consolidated source code file.

10. The system of claim 9, wherein the instructions stored in the memory further include instructions which, when executed by the processor, cause the processor to analyze the source code to identify missing dependencies of one or more missing copybooks, the one or more missing copybooks comprising one or more copybooks yet to be received by the system.

11. The system of claim 9, wherein the instructions stored in the memory further include instructions which, when executed by the processor, cause the processor to identify the one or more business rules based on a pattern driven search.

12. The system of claim 9, wherein the instructions stored in the memory further include instructions which, when executed by the processor, cause the processor to categorize the identified one or more business rules based on business terms and on technical terms.

13. The system of claim 12, wherein the instructions stored in the memory further include instructions which, when executed by the processor, cause the processor to map the technical terms to the business terms.

14. The system of claim 9, wherein the instructions stored in the memory further include instructions which, when executed by the processor, cause the processor to convert the extracted one or more business rules to a format suitable for importation into a business rule management system product.

15. The system of claim 9, further comprising a display monitor,
wherein the instructions stored in the memory further include instructions which, when executed by the processor, cause the processor to control the display monitor to graphically display at least one of the one or more extracted business rules.

16. A method of extracting business rules from source code, comprising:
receiving on a computing device the source code and a copybook associated with the source code;
analyzing the source code to identify a dependency on a portion of the copybook;
appending the identified portion of the copybook to the identified dependency in the source code to create a consolidated source code file;
identifying one or more business rules from the consolidated source code file; and
extracting the one or more business rules from the consolidated source code file.

17. The method of claim 16, further comprising analyzing the source code to identify missing dependencies of one or more missing copybooks, the one or more missing copybooks comprising one or more copybooks yet to be received by the computing device.

18. The method of claim 16, further comprising converting the extracted one or more business rules to a format suitable for importation into a business rule management system product.

19. The method of claim 16, further comprising categorizing the identified one or more business rules based on business terms and on technical terms.

20. The method of claim 19, further comprising mapping the technical terms to the business terms.
